(19) United States
(12) Patent Application Publication
(10) Pub. No.: US 2016/0039484 A1
(43) Pub. Date: Feb. 11, 2016

(54) Wheel Well Cover

(71) Applicant: Felton Magee, Washington, DC (US)

(72) Inventor: Felton Magee, Washington, DC (US)

(21) Appl. No.: 14/819,953

(22) Filed: Aug. 6, 2015

Related U.S. Application Data
(60) Provisional application No. 62/033,749, filed on Aug. 6, 2014.

(51) Int. Cl. B62D 65/16; B62D 25/16

(52) U.S. Cl. CPC B62D 65/16; B62D 25/16

(57) ABSTRACT

A method of utilizing an extension panel to minimize a radial safety clearance between a tire and a rim of a wheel well. The extension panel includes a convex edge and a concave edge. The extension panel is oriented parallel to a sidewall of a tire such that the convex edge is positioned flush against the rim. In the resulting position, the concave edge is positioned offset from a tread of the tire. A plurality of L-shaped brackets is utilized to attach the extension panel to the wheel well. Since the extension panel is attached to the wheel well, opening or closing a vehicle door is not disrupted. Moreover, since the concave edge is offset from the tread, the turning radius of the automobile is not interrupted.

The current application claims a priority to the U.S. Provisional Patent application Ser. No. 62/033,749 filed on Aug. 6, 2014.

### FIELD OF THE INVENTION

The present invention relates generally to a fender extension apparatus. More specifically, the present invention is a fender extension apparatus for reducing a gap between a wheel or tire of a vehicle and the edge of the wheel opening.

### BACKGROUND OF THE INVENTION

Automobiles are designed to satisfy different needs of the customer. As an example, certain automobiles are designed to have a lower center of gravity while other automobiles are designed to have a higher center of gravity. The gap between the tire and the undercarriage of the automobile widens with increasing height. The gap between the tire and the undercarriage of the automobile has a series of disadvantages. For instance, a wide gap can affect the aesthetically pleasing appearance of the automobile. Moreover, road debris can damage the undercarriage by entering through the gap between the tire and the undercarriage. On the other hand, debris can also damage surrounding vehicles by falling out from the gap between the tire and the undercarriage. The amount of rain splash made by automobiles also increases with the widening gap which can be dangerous to fellow drivers on the road. In order to address the issue, several wheel covers have been introduced throughout time. However, these wheel covers have a series of disadvantages.

Among these disadvantages, a major disadvantage is that the wheel well cover interferes with the turning radius of the automobile. The interference limits the users to utilizing these covers only on the rear wheels. As a result, the front wheel wells remain uncovered. Another disadvantage with the existing wheel well covers is the need to disassemble the cover when changing a tire. The process of initially removing the wheel well cover and then removing the tire can be a time consuming process. Therefore, the need for a method of covering the wheel well with no interference to the turning radius is clearly evident. Additionally, the need for a cover that allows the user to access the tire conveniently is also necessary.

The objective of the present invention is to address the aforementioned issues. In particular, the present invention introduces a method of attaching a wheel well cover to an automobile. The effective design ensures that the wheel cover does not interfere with the turning radius of the automobile. Moreover, the present invention protects the under carriage of the automobile against road debris, reduces the water splash from the tires, and also acts as an aerodynamic wheel cover.

### BRIEF DESCRIPTION OF THE DRAWINGS

FIG. 1 is a flowchart illustrating the basic overall process of the present invention.

FIG. 2 is a flowchart illustrating the basic overall process of mounting an extension panel.

FIG. 3 is a perspective view of the extension panel and the plurality of L-shaped brackets.

FIG. 4 is an exploded view of the extension panel and the plurality of L-shaped brackets.

FIG. 5 is a side view of the present invention used along with a tire.

FIG. 6 is a perspective view of the present invention being used with a front tire of an automobile.

### DETAIL DESCRIPTIONS OF THE INVENTION

All illustrations of the drawings are for the purpose of describing selected versions of the present invention and are not intended to limit the scope of the present invention.

The present invention introduces a method of covering a wheel well for an automobile. The effective design allows a user to utilize the present invention with no interference to the turning radius of the automobile. Moreover, the user is also allowed to change a tire or engage in any other tire related activities while the present invention is being used.

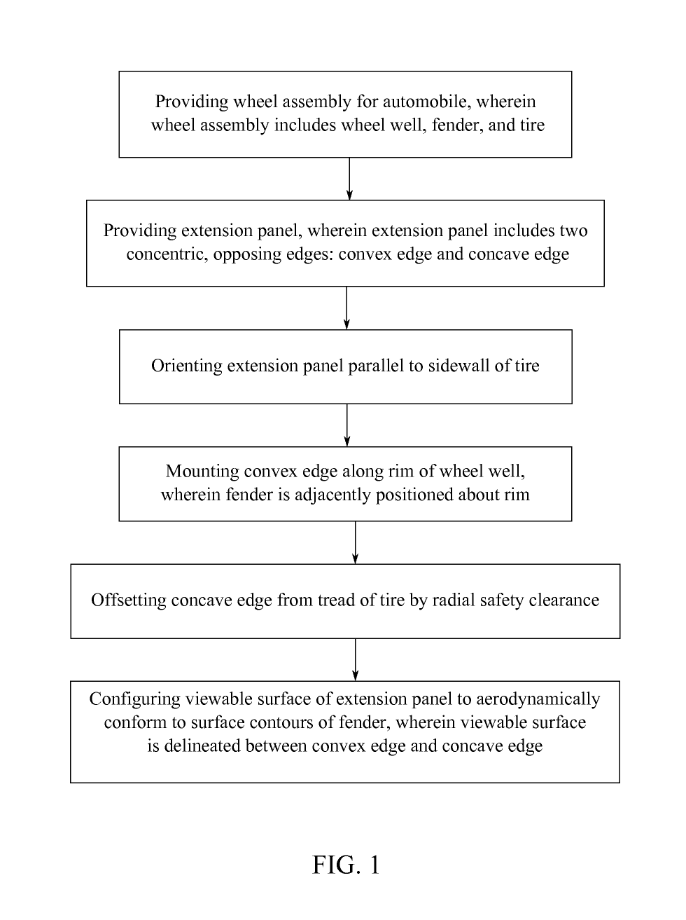

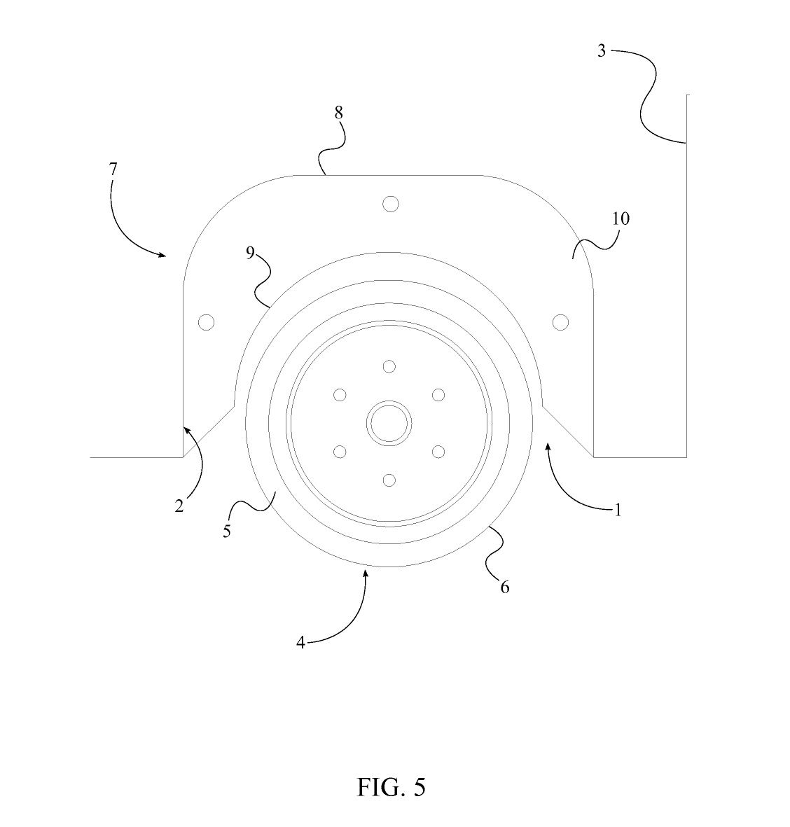

When utilizing the present invention, a wheel assembly is initially provided for an automobile. As seen in FIG. 1 and FIG. 5, the wheel assembly includes a wheel well 1, a fender 3, and a tire 4. The number of wheel assemblies can vary from one automobile to another. The number of wheel assemblies utilized can also depend on user preference. As an example, one user may prefer to utilize the present invention only on the rear wheel assemblies while another user may prefer to utilize the present invention on all wheel assemblies. When the wheel assembly is selected, an extension panel 7 is provided to be used on the wheel assembly. The extension panel 7 can be made of, but is not limited to being made of plastic. The material ensures that the extension panel 7 is not overly rigid or overly flexible. In the preferred embodiment of the present invention, the extension panel 7 has a crescent shape and includes two concentric, opposing edges. In particular, the extension panel 7 includes a convex edge 8 and a concave edge 9. Next, the extension panel 7 is oriented parallel to a sidewall 5 of the tire 4. In order to mount the extension panel 7, the convex edge 8 is mounted along a rim 2 of the wheel well 1. As a result, the fender 3 is adjacently positioned about the rim 2. When the convex edge 8 is mounted, the concave edge 9 if positioned offset from a tread 6 of the tire 4 by a radial safety clearance. In the preferred embodiment of the present invention, the radial safety clearance is set to be approximately 1 inch. However, according to user preference the radial safety clearance can vary in other embodiments of the present invention. The radial safety clearance ensures that the present invention does not interfere with the turning radius of the automobile. When the extension panel 7 is mounted, a viewable surface 10 of the extension panel 7, which is delineated between the convex edge 8 and the concave edge 9, is configured to aerodynamically conform to surface contours of the fender 3. The positioning of the extension panel 7 is such that the original shape of the automobile remains unchanged by utilizing the present invention.

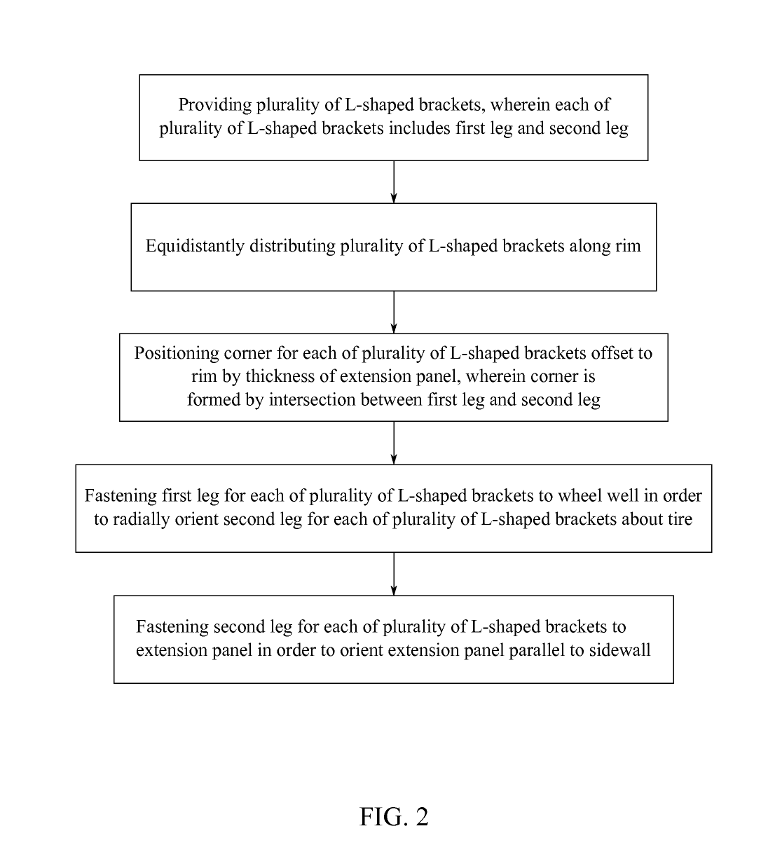

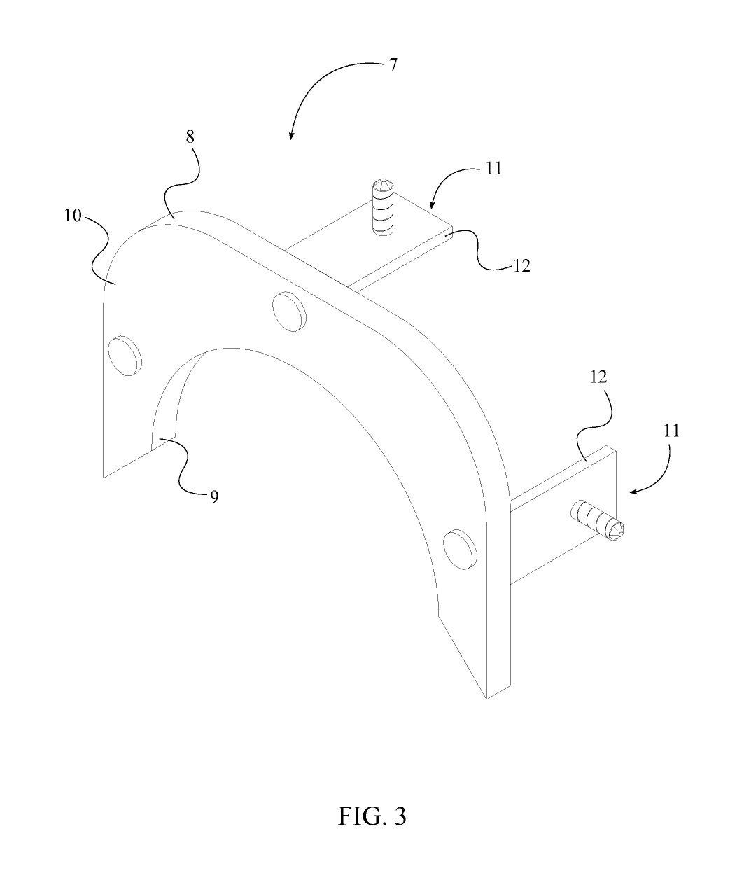

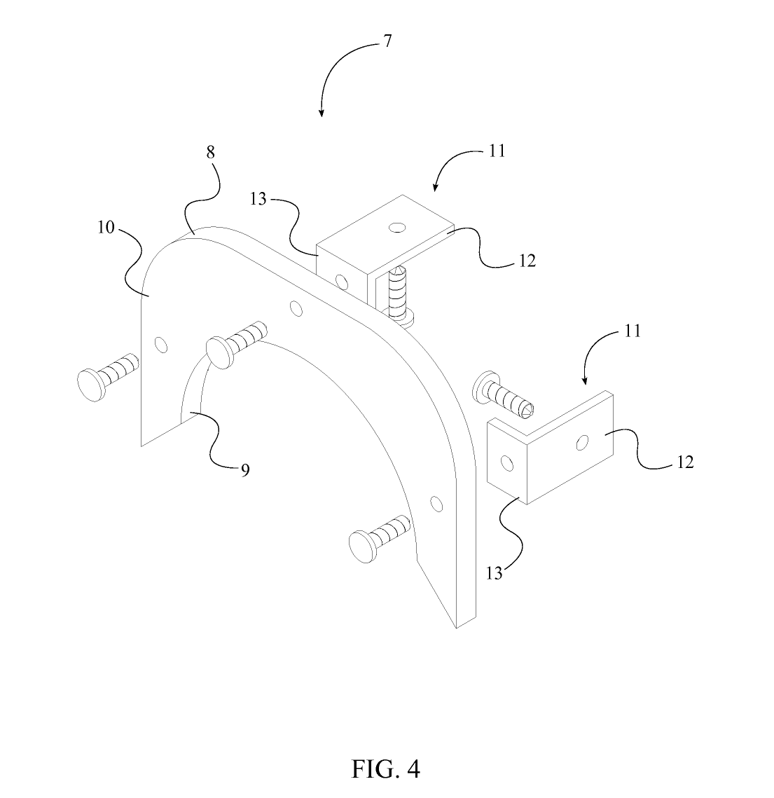

As seen in FIG. 3 and FIG. 4, the extension panel 7 is mounted to the rim 2 through a plurality of L-shaped brackets 11 in the preferred embodiment of the present invention. However, a different attachment mechanism can be used in other embodiments of the present invention. Each of the plurality of L-shaped brackets 11 includes a first leg 12 and a second leg 13 which are positioned perpendicular to each other. In order to provide maximum stability to the extension panel 7, the plurality of L-shaped brackets 11 are equidistantly distributed along the rim 2. The number of L-shaped brackets used can vary in different embodiments of the present invention. As previously mentioned, the extension panel 7 aerodynamically conforms to the surface contours of the fender 3. In order to do so, a corner of each of the plurality of L-shaped brackets 11 is positioned offset to the rim 2 by a thickness of the extension panel 7. The corner is selected to be formed by an intersection between the first leg 12 and the second leg 13. As an example, if the extension panel 7 has a thickness of 10 millimeters, the corner is positioned 10 millimeters offset from the rim 2. When each of the plurality of L-shaped brackets 11 are appropriately positioned, the first leg 12 for each of the plurality of L-shaped brackets 11 is fastened to the wheel well 1 such that the second leg 13 for each of the plurality of L-shaped brackets 11 is radially oriented about the tire 4. Next, the second leg 13 of each of the plurality of L-shaped brackets 11 is fastened to the extension panel 7 in order to orient the extension panel 7 parallel to the sidewall 5 of the tire 4. The process of utilizing the plurality of L-shaped brackets 11 is illustrated in FIG. 2.

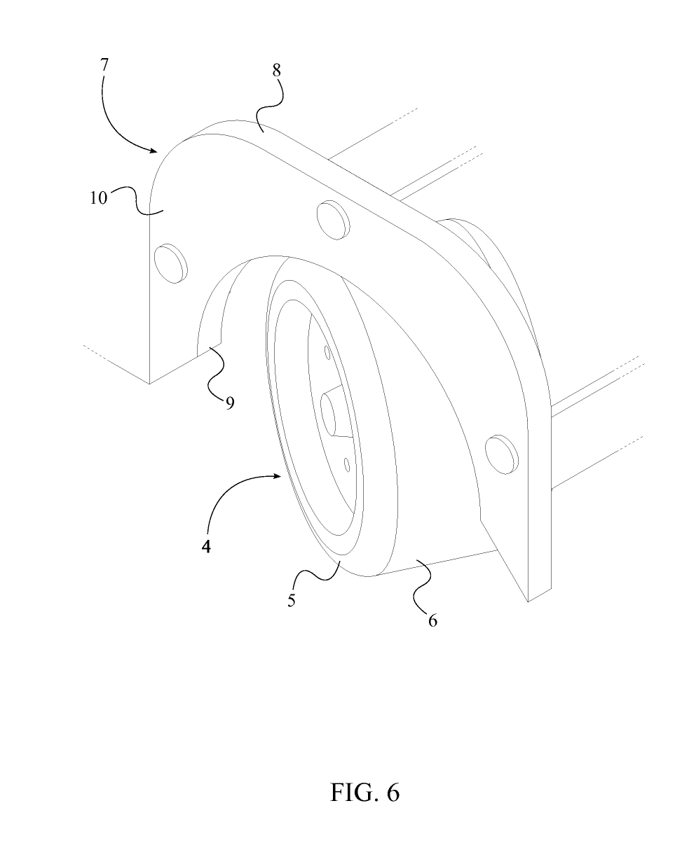

Based on the configuration the present invention is being used in, the present invention can have a steer wheel configuration for the tire 4. If the present invention is in the steer wheel configuration, the radial safety clearance is sized in order to compensate for a turning radius of the tire 4. As a result, the user can handle the automobile uninterrupted since the tire 4 has no contact with the extension panel 7 as illustrated in FIG. 6. The present invention can also be used in a straight wheel configuration for the wheel assembly. The straight wheel configuration can vary from one automobile to another. For instance, if the automobile is a rear wheel drive, the straight wheel configuration is applied to the drive wheels. If the automobile is a front wheel drive, the straight wheel configuration is applied to the neutral wheels. On the other hand, if the automobile is a four wheel drive, the straight wheel configuration is applied to the rear drive wheels. In the straight wheel configuration, the radial safety clearance is sized to minimize a distance between the concave edge 9 and the tread 6 of the tire 4. As in the steer wheel configuration, the tire 4 has no contact with the extension panel 7 in the straight wheel configuration. Therefore, the user is allowed to change a tire 4 or engage in any other tire 4 related activity uninterrupted by the presence of the extension panel 7.

As previously discussed, the corner of each of the plurality of L-shaped brackets 11 is offset from the rim 2. Therefore, the present invention can be used on a wide variety of automobiles. In particular, in some automobiles the fender 3 shares the rim 2 of the wheel well 1 with a concave distal edge of an automobile door. In such instances, if the extension panel 7 is mounted onto the rim 2, the opening and closing of the automobile door is disrupted. Since the present invention attaches the extension panel 7 to the corner of each of the plurality of L-shaped brackets 11 which is offset from the rim 2, the opening and closing of the door is not interrupted.

The following process flow can be followed when utilizing the present invention. Initially, the extension panel 7 is oriented parallel to the sidewall 5. Next, the convex edge 8 of the extension panel 7 is mounted along the rim 2 of the wheel well 1 such that the concave edge 9 is offset from the tread 6 of the tire 4. The distance between the concave edge 9 and the tread 6 can vary in different embodiments of the present invention. When the extension panel 7 is appropriately positioned, the extension panel 7 is fastened to the second leg 13 of each of the plurality of L-shaped brackets 11. Since the first leg 12 of each of the L-shaped brackets 11 is fastened to the wheel well 1, a secure connection is established between the extension panel 7 and the automobile. The method introduced by the present invention yields multiple benefits. As previously discussed, the extension panel 7 aerodynamically conforms to the surface contours of the fender 3. Therefore, the automobile obtains a more aerodynamically advantageous shape which can help reduce gas consumption. In the preferred embodiment of the present invention, the radial safety clearance is approximately 1 inch. Therefore, the probability of any road debris damaging the wheel well 1 is drastically reduced with the minimized distance between the tire 4 and the rim 2. Thus, utilizing the present invention can help the longevity of the automobile. The present invention addresses another issue which has been prevalent with most automobiles. More specifically, the present invention reduces water splash. Considering the number of road accidents that occur due to rainy conditions, the present invention can be extremely beneficial in maintaining safe road conditions for the user and other drivers.

Although the invention has been explained in relation to its preferred embodiment, it is to be understood that many other possible modifications and variations can be made without departing from the spirit and scope of the invention as hereinafter claimed.

What is claimed is:

1. A method of covering a wheel well for an automobile, the method comprises the steps of:
providing a wheel assembly for an automobile, wherein the wheel assembly includes a wheel well, a fender, and a tire;
providing an extension panel, wherein the extension panel includes two concentric, opposing edges: a convex edge and a concave edge;
orienting the extension panel parallel to a sidewall of the tire;
mounting the convex edge along a rim of the wheel well, wherein the fender is adjacently positioned about the rim;
offsetting the concave edge from a tread of the tire by a radial safety clearance; and
configuring a viewable surface of the extension panel to aerodynamically conform to surface contours of the fender, wherein the viewable surface is delineated between the convex edge and the concave edge.

2. The method of covering a wheel well for an automobile, the method as claimed in 1 comprises the steps of:
providing a plurality of L-shaped brackets, wherein each of the plurality of L-shaped brackets includes a first leg and a second leg;
equidistantly distributing the plurality of L-shaped brackets along the rim;
positioning a corner for each of the plurality of L-shaped brackets offset to the rim by a thickness of the extension panel, wherein the corner is formed by an intersection between the first leg and the second leg;
fastening the first leg for each of the plurality of L-shaped brackets to the wheel well in order to radially orient the second leg for each of the plurality of L-shaped brackets about the tire; and
fastening the second leg for each of the plurality of L-shaped brackets to the extension panel in order to orient the extension panel parallel to the sidewall.

3. The method of covering a wheel well for an automobile, the method as claimed in 1 comprises the steps of:
providing a steer wheel configuration for the tire; and
sizing the radial safety clearance in order to compensate for a turning radius of the tire.

4. The method of covering a wheel well for an automobile, the method as claimed in 1 comprises the steps of:
providing a straight wheel configuration for the wheel assembly; and
sizing the radial safety clearance in order to minimize a distance between the concave edge and the tread.

5. The method of covering a wheel well for an automobile, the method as claimed in 1, wherein the fender shares the rim of the wheel well with a concave distal edge of an automobile door.
